(19) United States
(12) Patent Application Publication
(10) Pub. No.: US 2026/0332201 A1
(43) Pub. Date: Oct. 22, 2026

(54) ANTENNA SWITCHING FOR FREQUENCY DIVISION DUPLEXING PERFORMANCE

(71) Applicant: Lenovo (United States) Inc., Morrisville, NC (US)

(72) Inventors: John R Mura, Clarendon Hills, IL (US); Minchul Park, Arlington Heights, IL (US); Jaehyun Hwang, Buffalo Grove, IL (US)

(73) Assignee: Lenovo (United States) Inc., Morrisville, NC (US)

(21) Appl. No.: 19/383,526

(22) Filed: Nov. 7, 2025

(51) Int. Cl. H04B 7/06; H04B 7/08; H04L 5/14

(52) U.S. Cl. CPC H04B 7/0602; H04B 7/0802; H04L 5/14

(57) ABSTRACT

Various aspects of the present disclosure relate to antenna switching for frequency division duplexing (FDD) performance. An apparatus, such as a user equipment (UE), has a duplexed transmit and receive antenna that includes a primary transmit antenna and a primary receive antenna. The UE also includes a switchable physical receive-only antenna. The UE may switch to the switchable physical receive-only antenna to separate the primary receive antenna from the primary transmit antenna of the duplexed transmit and receive antenna.

### TECHNICAL FIELD

The present disclosure relates to wireless communications, and more specifically to user equipment (UE) antenna switching for wideband channel frequency division duplexing (FDD) performance.

### BACKGROUND

A wireless communications system may include one or multiple network communication devices, which may be otherwise known as network equipment (NE), supporting wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The apparatuses (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE includes a duplexed transmit and receive antenna with a primary transmit antenna and a primary receive antenna, and includes a switchable physical receive-only antenna. The UE may be configured to, capable of, or operable to switch to the switchable physical receive-only antenna to separate the primary receive antenna from the primary transmit antenna of the duplexed transmit and receive antenna.

A processor (e.g., a standalone processor chipset, or a component of the UE) for wireless communication is described. The processor may be configured to, capable of, or operable to perform one or more operations as described herein. For example, the processor may be configured to, capable of, or operable to switch to a switchable physical receive-only antenna to separate a primary receive antenna from a primary transmit antenna of a duplexed transmit and receive antenna, where the UE includes the duplexed transmit and receive antenna comprising the primary transmit antenna and the primary receive antenna; and the UE includes the switchable physical receive-only antenna.

A method performed or performable by a UE for wireless communication is described. The method may include receiving wireless communication via a duplexed transmit and receive antenna comprising a primary transmit antenna and a primary receive antenna; and switching to a switchable physical receive-only antenna that separates the primary receive antenna from the primary transmit antenna of the duplexed transmit and receive antenna.

In some implementations of the UE, the processor, and the method described herein, the switchable physical receive-only antenna is isolated from the primary transmit antenna based at least in part on a physical distance between the switchable physical receive-only antenna and the primary transmit antenna.

In some implementations, the UE, the processor, and the method may further be configured to, capable of, or operable to optimize antenna tuning based at least in part on isolation of the switchable physical receive-only antenna from the primary transmit antenna that is separated from the primary receive antenna.

In some implementations, the duplexed transmit and receive antenna is configured for FDD operation for simultaneous two-way transmit and receive, and the UE, the processor, and the method may further be configured to, capable of, or operable to detect channel bandwidth during the FDD operation, and switch to the switchable physical receive-only antenna based on one or more of the channel bandwidth, assigned resources, or data rate.

In some implementations, the UE, the processor, and the method may further be configured to, capable of, or operable to transmit a capability message that indicates the UE is configured with at least the switchable physical receive-only antenna.

In some implementations of the UE, the processor, and the method described herein, the capability message further indicates an uplink (UL) allocation that is supported by an antenna configuration of the UE.

In some implementations, the UE includes the duplexed transmit and receive antenna, the switchable physical receive-only antenna, and at least one diversity receive antenna; and the UE, the processor, and the method may further be configured to, capable of, or operable to disable the receive antenna of the duplexed transmit and receive antenna, and enable the switchable physical receive-only antenna and the at least one diversity receive antenna for FDD.

In some implementations, the UE includes a primary receiver associated with the duplexed transmit and receive antenna, and at least one secondary receiver and associated diversity receive antenna; and the UE, the processor, and the method may further be configured to, capable of, or operable to disable the primary receiver based at least in part on channel bandwidth and an UL data rate during FDD operation; and enable the at least one secondary receiver as a primary signal receiver.

In some implementations, the UE, the processor, and the method may further be configured to, capable of, or operable to operate in a first mode with the duplexed transmit and receive antenna enabled; or operate in a second mode with the switchable physical receive-only antenna and the primary receive antenna separated from the primary transmit antenna of the duplexed transmit and receive antenna; and at least one of determine, by the UE, to switch from the first mode to the second mode; or receive, from a NE, a request to switch from the first mode to the second mode.

In some implementations, the UE, the processor, and the method may further be configured to, capable of, or operable to receive, from the NE, an instruction to switch from the second mode to the first mode; and measure and report channel metrics for a primary receiver associated with the duplexed transmit and receive antenna.

An NE (e.g., a base station) for wireless communication is described. The NE may be configured to, capable of, or operable to perform one or more operations as described herein. For example, the NE may be configured to, capable of, or operable to receive, from a UE, a capability message that indicates the UE is configured with a switchable physical receive-only antenna, as well as a duplexed transmit and receive antenna comprising a primary transmit antenna and a primary receive antenna; and transmit, to the UE, a request to switch from a first mode to a second mode, where the UE is configured to at least one of operate in the first mode with the duplexed transmit and receive antenna enabled, or operate in the second mode with the switchable physical receive-only antenna and the primary receive antenna separated from the primary transmit antenna of the duplexed transmit and receive antenna.

A processor (e.g., a standalone processor chipset, or a component of an NE) for wireless communication is described. The processor may be configured to, capable of, or operable to perform one or more operations as described herein. For example, the processor may be configured to, capable of, or operable to receive, from a UE, a capability message that indicates the UE is configured with a switchable physical receive-only antenna, as well as a duplexed transmit and receive antenna comprising a primary transmit antenna and a primary receive antenna; and transmit, to the UE, a request to switch from a first mode to a second mode, where the UE is configured to at least one of operate in the first mode with the duplexed transmit and receive antenna enabled, or operate in the second mode with the switchable physical receive-only antenna and the primary receive antenna separated from the primary transmit antenna of the duplexed transmit and receive antenna.

A method performed or performable by an NE (e.g., a base station) for wireless communication is described. The method may include receiving, from a UE, a capability message that indicates the UE is configured with a switchable physical receive-only antenna, as well as a duplexed transmit and receive antenna comprising a primary transmit antenna and a primary receive antenna; and transmitting, to the UE, a request to switch from a first mode to a second mode, where the UE is configured to at least one of operate in the first mode with the duplexed transmit and receive antenna enabled, or operate in the second mode with the switchable physical receive-only antenna and the primary receive antenna separated from the primary transmit antenna of the duplexed transmit and receive antenna.

### BRIEF DESCRIPTION OF THE DRAWINGS

FIG. 1 illustrates an example of a wireless communications system in accordance with aspects of the present disclosure.

FIG. 2 illustrates an example of transmit self desensitization (Tx self desense), in accordance with aspects of the present disclosure.

FIG. 3 illustrates an example of frequency band configuration and intermodulation distortion (IMD), in accordance with aspects of the present disclosure.

FIG. 4 illustrates an example of improvement results using an antenna configuration with a switchable primary receive-only antenna (sPRx), in accordance with aspects of the present disclosure.

FIG. 5 illustrates an example hardware (HW) configuration that includes an sPRx with a duplicative Rx filter, in accordance with aspects of the present disclosure.

FIG. 6 illustrates another example HW configuration that includes an sPRx that may be switched with a switchable duplexer, in accordance with aspects of the present disclosure.

FIG. 7 illustrates another example HW configuration that includes an sPRx implemented as a second diversity Rx antenna, in accordance with aspects of the present disclosure.

FIG. 8 illustrates example modes of operation 800 utilizing an sPRx, in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of an NE in accordance with aspects of the present disclosure.

FIG. 12 illustrates an example of a flowchart of a method performed by a UE in accordance with aspects of the present disclosure.

FIG. 13 illustrates an example of a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. Wireless communications systems continue to evolve in capability and flexibility across various radio access technologies, including 5G radio access technology and increasingly, 6G radio access technology. In particular, channel bandwidths have increased significantly from earlier generations of the radio access technologies. In addition, 5G has increased the use of carrier aggregation, with multiple downlink (DL) and/or UL channels being received at the same time, and in the same frequency band. In 5G, FDD is a duplexing technique used to separate UL and DL transmissions for simultaneous two-way transmit (Tx) and receive (Rx). For example, a UE and an NE may both transmit and receive at the same time. Additionally, Sub 1 GHz cellular bands (e.g., FR1 low bands 410 MHz-960 MHz) are implemented for FDD use, and have been utilized to support 5G wireless communication. The structure of these frequency bands in terms of duplex gap and duplex spacing was developed for the previous generations of cellular standards that did not support the wider 5G channel bandwidth, and did not anticipate the widespread use of carrier aggregation.

In implementations of radio access technologies, FDD bands accommodate simultaneous Tx and Rx transmissions at different frequencies. The channel carrier frequency for Tx and Rx are separated by the duplex spacing, which initially was fixed for a given frequency band. For a fixed duplex spacing, as the channel bandwidth has increased, the gap between the Tx and Rx transmission spectrum in use for a given channel has decreased. Because the gap between the Tx and Rx transmission spectrum has decreased, undesired non-linear intermodulation (IM) products (e.g., of order 3, 5, and 7) that are at a higher amplitude closer to the desired Tx signal may partially overlap the desired Rx channel, causing in-band distortion and degraded Rx performance for these larger channel bandwidths. This is also referred to as Tx self desense, which is caused by the Tx signal overlapping the Rx signal path, reducing receiver sensitivity. In these instances, the amount of Tx power in the Rx band is dependent on the duplexer Tx bandpass filter attenuation in the Rx sub-band frequency.

In the implementations of the radio access technologies, Rx carrier aggregation allows for additional DL channels being added for wireless communication signaling, even in the same frequency band, which is referred to as intraband DL carrier aggregation (DLCA). If an additional channel is added between primary channel Tx and Rx carriers, similar issues may occur when high-level undesired non-linear IM products interfere with reception of a secondary DL receive channel. In implementations, UL carrier aggregation (ULCA) in a same frequency band may also be utilized, and similarly, with a secondary UL between the primary channel Tx and Rx carriers, similar effects of IM product interference may result in the DL Rx.

Typical 4G and 5G cellular handsets (e.g., UEs) utilize two or more receivers, and one transmitter with the primary receiver duplexed with the transmitter. In recent implementations, two Tx antennas may be used for UL multiple input multiple output (MIMO) and transmit diversity (TxD). The primary receiver has traditionally been duplexed with the Tx antenna, such that the Tx and Rx share the same physical antenna. Although the Rx and Tx are at different frequencies, there is still an expectation of some degree in reciprocity between the two sub-channels (Rx and Tx). Also, UL power control may be influenced by the DL reference signal received power (RSRP). This quasi-reciprocity is involved with acquisition of the network through the random access channel (RACH), during which a UE attaches to the network. The initial selection and acquisition of the frequency band may be primarily based on the Rx signal condition with the expectation that the UL path loss would be proportional to the Rx RSRP levels at the primary receiver. If the Tx and primary Rx sub-bands are separated out to two physical antennas, then one antenna may perform quite differently than the other antenna, depending on whether one of the antennas is degraded by external factors, such as when one antenna is partially covered or blocked, but the other antenna is not. With UL MIMO or TxD that uses dual Tx antennas, the secondary receiver may typically be duplexed with a second Tx antenna, which can adversely impact both the primary and diversity Rx antennas for wider channel bandwidths (BWs).

In aspects of this disclosure, the described techniques provide for a switchable primary Rx-only antenna, such as may be implemented as an additional physical antenna in a UE. In one or more implementations, a UE includes a duplexed Tx and Rx antenna that has a primary Tx antenna and a primary Rx antenna, and the UE also includes a switchable physical Rx-only antenna. The UE may then switch to the switchable physical Rx-only antenna to separate the primary Rx antenna from the primary Tx antenna of the duplexed Tx and Rx antenna. Notably, the switchable primary Rx-only antenna is a second physical primary Rx antenna, in addition to the conventional UE two receiver, two physical antenna configuration. This additional switchable antenna provides a UE configuration with three physical antennas, and the third, switchable antenna is utilized as a switchable primary Rx-only antenna to separate the primary Rx antenna from the primary Tx antenna. The switchable primary Rx-only antenna (also referred to herein as sPRx) may be switched to the primary receiver in place of the duplexed primary Tx and Rx physical antenna, particularly during larger BW operation.

Aspects of the present disclosure are described in the context of a wireless communications system. In the wireless communications system, a UE and an NE (e.g., a base station, gNB, network entity, network node) may support wireless communication, including reception and/or transmission of wireless communication using time-frequency resources. For example, the UE and the NE may support communicating signals (e.g., carrying control information, data, or the like). It should be understood that various terms may be used interchangeably with “communicating,” such as “signaling,” “transmitting,” “receiving,” “outputting,” “forwarding,” “relaying,” “retrieving,” “obtaining,” and so forth.

Additional aspects of the present disclosure are described in the context of component diagrams, process flows, method flowcharts, etc. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein, but is to be accorded the broadest scope consistent with the principles and novel features disclosed herein.

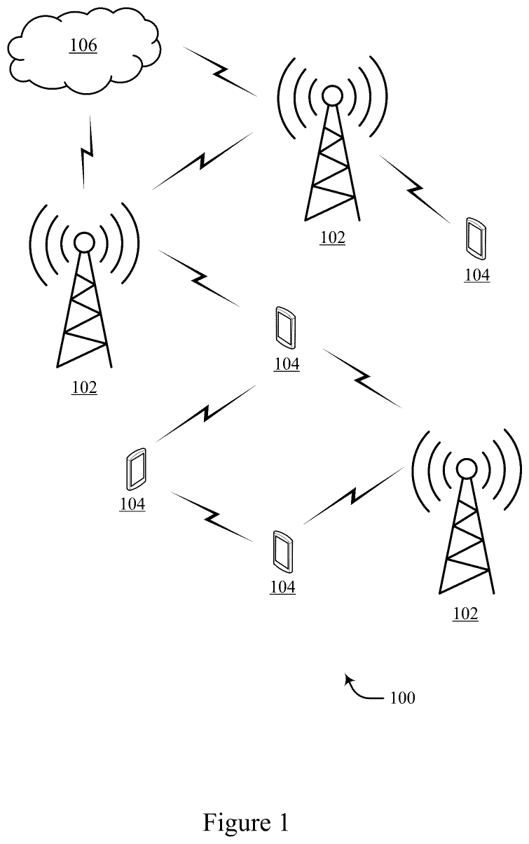

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, infrastructure, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

An NE 102 and a UE 104 in the wireless communications system 100 may support aspects of the described techniques for antenna switching for FDD performance for wideband channels. According to implementations, one or more of the NEs 102 and the UEs 104 are operable to implement various aspects of the techniques described with reference to the present disclosure. For example, a UE 104 includes a duplexed transmit and receive antenna with a primary transmit antenna and a primary receive antenna, and includes a switchable physical receive-only antenna. The UE 104 may be configured to, capable of, or operable to switch to the switchable physical receive-only antenna to separate the primary receive antenna from the primary transmit antenna of the duplexed transmit and receive antenna. An NE 102 (e.g., a base station, gNB) may receive, from a UE 104, a capability message that indicates the UE is configured with a switchable physical receive-only antenna, as well as a duplexed transmit and receive antenna comprising a primary transmit antenna and a primary receive antenna. The NE 102 may transmit, to the UE 104, a request to switch from a first mode to a second mode, where the UE is configured to at least one of operate in the first mode with the duplexed transmit and receive antenna enabled, or operate in the second mode with the switchable physical receive-only antenna and the primary receive antenna separated from the primary transmit antenna of the duplexed transmit and receive antenna.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Wireless communications systems continue to evolve in capability and flexibility across various radio access technologies, including 5G radio access technology and increasingly, 6G radio access technology. In particular, channel bandwidths have increased significantly from earlier generations of the radio access technologies. In addition, 5G has increased the use of carrier aggregation, with multiple DL and/or UL channels being received at the same time, and in the same frequency band. In 5G, FDD is a duplexing technique used to separate UL and DL transmissions for simultaneous two-way Tx and Rx. For example, a UE and an NE may both transmit and receive at the same time. Additionally, Sub 1 GHz cellular bands (e.g., FR1 low bands 410 MHz-960 MHz) are implemented for FDD use, and have been utilized to support 5G wireless communication. The structure of these frequency bands in terms of duplex gap and duplex spacing was developed for the previous generations of cellular standards that did not support the wider 5G channel bandwidth, and did not anticipate the widespread use of carrier aggregation.

In implementations of radio access technologies, FDD bands accommodate simultaneous Tx and Rx transmissions at different frequencies. The channel carrier frequency for Tx and Rx are separated by the duplex spacing, which initially was fixed for a given frequency band. For a fixed duplex spacing, as the channel bandwidth has increased, the gap between the Tx and Rx transmission spectrum in use for a given channel has decreased. Because the gap between the Tx and Rx transmission spectrum has decreased, undesired non-linear IM products (e.g., of order 3, 5, and 7) that are at a higher amplitude closer to the desired Tx signal may partially overlap the desired Rx channel, causing in-band distortion and degraded Rx performance for these larger channel bandwidths. This is also referred to as Tx self desense, which is caused by the Tx signal overlapping the Rx signal path, reducing receiver sensitivity. In these instances, the amount of Tx power in the Rx band is dependent on the duplexer Tx bandpass filter attenuation in the Rx sub-band frequency.

In the implementations of the radio access technologies, Rx carrier aggregation allows for additional DL channels being added for wireless communication signaling, even in the same frequency band, which is referred to as intraband DLCA. If an additional channel is added between primary channel Tx and Rx carriers, similar issues may occur when high-level undesired non-linear IM products interfere with reception of a secondary DL receive channel. In implementations, ULCA in a same frequency band may also be utilized, and similarly, with a secondary UL between the primary channel Tx and Rx carriers, similar effects of IM product interference may result in the DL Rx.

Typical 4G and 5G cellular handsets (e.g., UEs) utilize two or more receivers, and one transmitter with the primary receiver duplexed with the transmitter. In recent implementations, two Tx antennas may be used for UL MIMO and TxD. The primary receiver has traditionally been duplexed with the Tx antenna, such that the Tx and Rx share the same physical antenna. Although the Rx and Tx are at different frequencies, there is still an expectation of some degree in reciprocity between the two sub-channels (Rx and Tx). Also, UL power control may be influenced by the DL RSRP. This quasi-reciprocity is involved with acquisition of the network through the RACH, during which a UE attaches to the network. The initial selection and acquisition of the frequency band may be primarily based on the Rx signal condition with the expectation that the UL path loss would be proportional to the Rx RSRP levels at the primary receiver. If the Tx and primary Rx sub-bands are separated out to two physical antennas, then one antenna may perform quite differently than the other antenna, depending on whether one of the antennas is degraded by external factors, such as when one antenna is partially covered or blocked, but the other antenna is not. With UL MIMO or TxD that uses dual Tx antennas, the secondary receiver may typically be duplexed with a second Tx antenna, which can adversely impact both the primary and diversity Rx antennas for wider channel BWs.

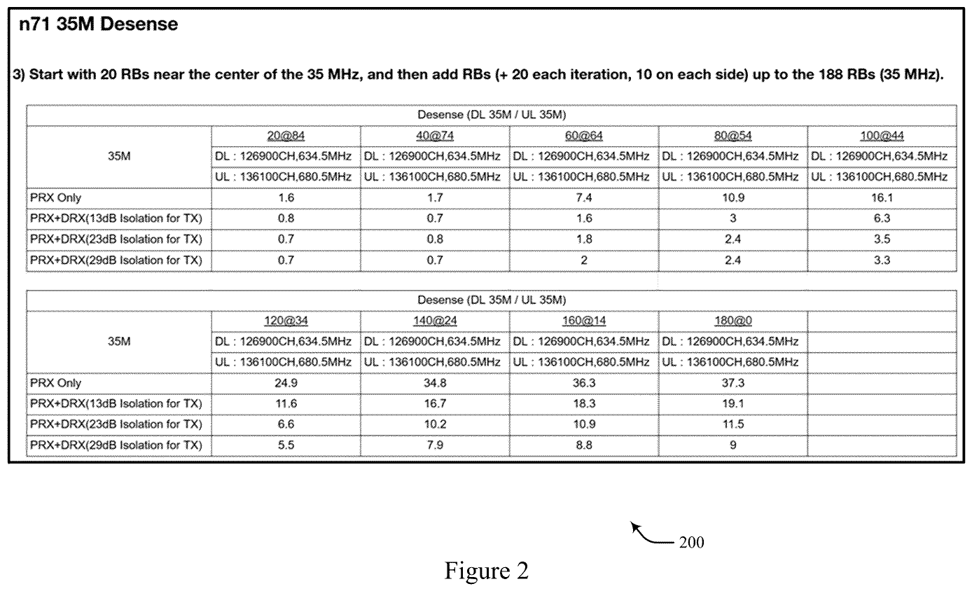

FIG. 2 illustrates an example 200 of Tx self desense in accordance with aspects of the present disclosure. In this example 200, results of Tx self desense measurements on frequency band n71 for 35 MHz bandwidth are illustrated. The Tx self desense is shown for a single 35 MHz channel that, for this band, occupies the entire band as the UL Tx resources are expanded in 20 resource block (RB) increments from the center of the channel. The first row shows the impact to the primary receiver in terms of self desense in dB degradation to the point when Tx is at the lowest Tx power level. As the allocation increases, non-linear IM products eventually impact the primary Rx and degrade the primary receiver, as illustrated by the increasing PRx desense measurement. The secondary receiver not measured directly in this data set, however when combined with the primary Rx, is less impacted due to additional isolation between the Tx physical antenna and the secondary receiver antenna.

The combined performance of primary and secondary receiver show a lower impact, however the secondary receiver is also affected at some point, resulting in an overall significant degradation in the worst case scenario of full Tx allocation. In addition, if one receive path is degraded, DL MIMO operation is severely impacted and the benefits of DL MIMO can not be achieved due to the highly unbalanced signal-to-noise ratios (SNRs) of the two receive paths. Peak throughput may be limited to half due to the network (NW) reverting to single input single output (SISO) operation. If dual Tx antennas were to be used as in UL MIMO or TxD, then the secondary Rx antenna would also be impacted to the same degree as the primary Rx antenna. Because this is Tx induced self desense, there is a degree of randomness depending on the UL scheduling that may present issues, since the performance may not be steady state, but rather vary depending on the UL scheduling. The result may be similar to Rx fading on the PRx. This will cause exacerbated performance degradation due to the sudden change in performance of the primary Rx and force both receivers to stay active, even though only one might be suitable if the noise was steady and at a low level.

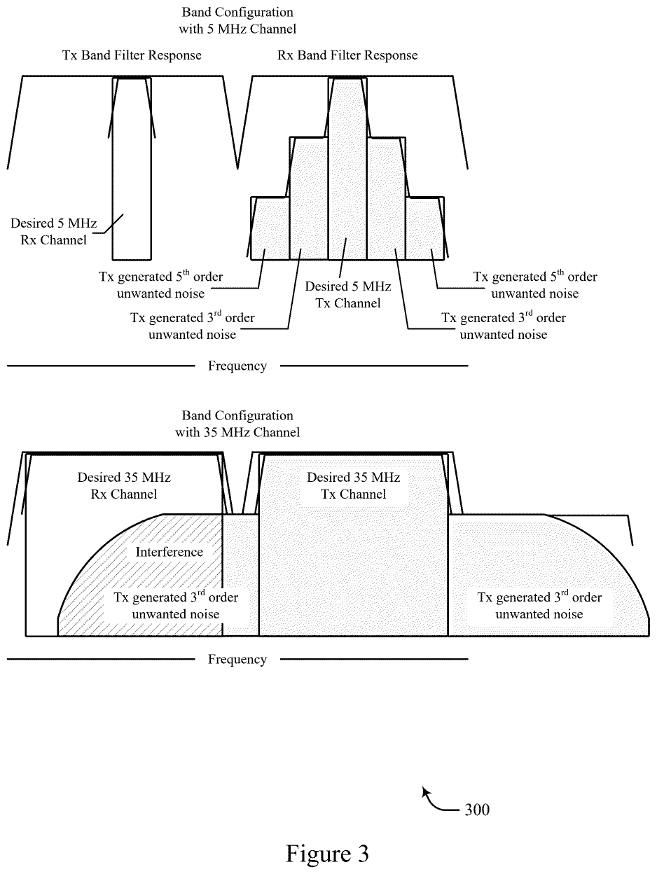

FIG. 3 illustrates an example 300 of frequency band configuration and IMD in accordance with aspects of the present disclosure. This example 300 illustrates an n71 frequency band configuration and IMD 3 and 5 products for 5 MHz and 35 MHz channels, and shows the increased interference overlap with the desired Rx for the 35 MHz channel.

In some implementations, there are several potential solutions that may be used to reduce the problems described herein. For example, a solution may be implemented to prevent simultaneous Tx and Rx transmissions, particularly for large UL allocations. It may be possible to reduce the Tx allocation for simultaneous Tx and Rx, however this may also reduce NW capacity. In another example, a solution may be implemented to linearize the radio front end. There may be some opportunity to linearize the radio transmit chain, but this will generally come at the expense of current drain. It may also require specialized components and designs not generally in use in handsets (e.g., UEs), which comes with higher implementation costs. In another example, a solution may implement mathematical nonlinear cancellation with digital signal processing (DSP). This option may reduce the interfering noise level to the extent that the non-linear effect can be modeled as a linear time invariant system. In general, this may reduce the noise level to a large extent, but not completely due to memory effects that make the system only partially linear time invariant. This will also result in significant computation and will increase current drain. In another example, a solution may be implemented to use better filters, which could be developed with higher attenuation in the Rx band on the Tx band pass filter (BPF). However, these filters generally will result in larger physical size, as well as higher insertion loss due to more filter stages, thus increasing current drain. These filter devices may add expensive and will be required on each individual frequency band. Notably, any of these described example solutions may be implemented together or separately, and may be implemented with any aspects of the described techniques for a switchable primary Rx-only antenna.

In aspects of this disclosure, the described techniques provide for a switchable primary Rx-only antenna, such as may be implemented as an additional physical antenna in a UE. In one or more implementations, a UE includes a duplexed Tx and Rx antenna that has a primary Tx antenna and a primary Rx antenna, and the UE also includes a switchable physical Rx-only antenna. The UE may then switch to the switchable physical Rx-only antenna to separate the primary Rx antenna from the primary Tx antenna of the duplexed Tx and Rx antenna. Notably, the switchable primary Rx-only antenna is a second physical primary Rx antenna, in addition to the conventional UE two receiver, two physical antenna configuration. This additional switchable antenna provides a UE configuration with three physical antennas, and the third, switchable antenna is utilized as a switchable primary Rx-only antenna to separate the primary Rx antenna from the primary Tx antenna. The switchable primary Rx-only antenna (also referred to herein as sPRx) may be switched to the primary receiver in place of the duplexed primary Tx and Rx physical antenna, particularly during larger BW operation.

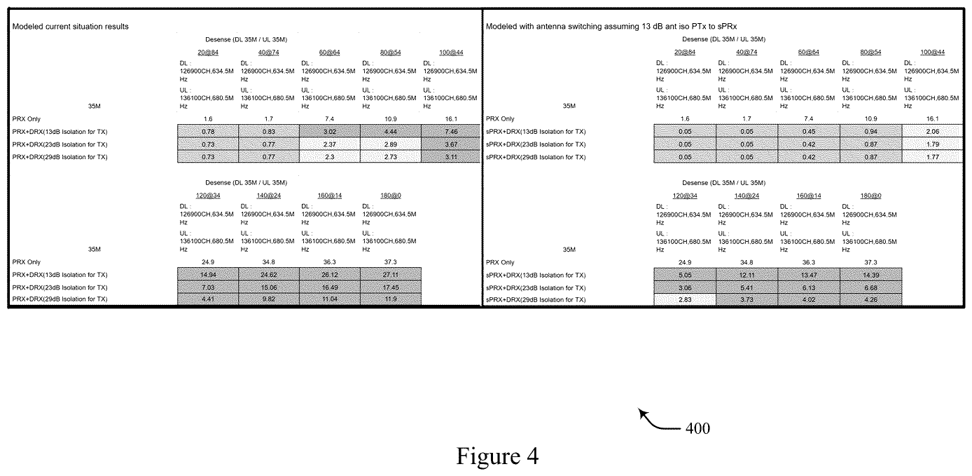

FIG. 4 illustrates an example 400 of improvement results using an antenna configuration with an sPRx, in accordance with aspects of the present disclosure. In this example 400, for a UE that is implemented with an sPRx antenna, UL allocation may be up to 100 RBs with low Rx degradation with 13 dB of switched antenna to Tx antenna isolation. Higher isolation would further improve allowed UL allocations.

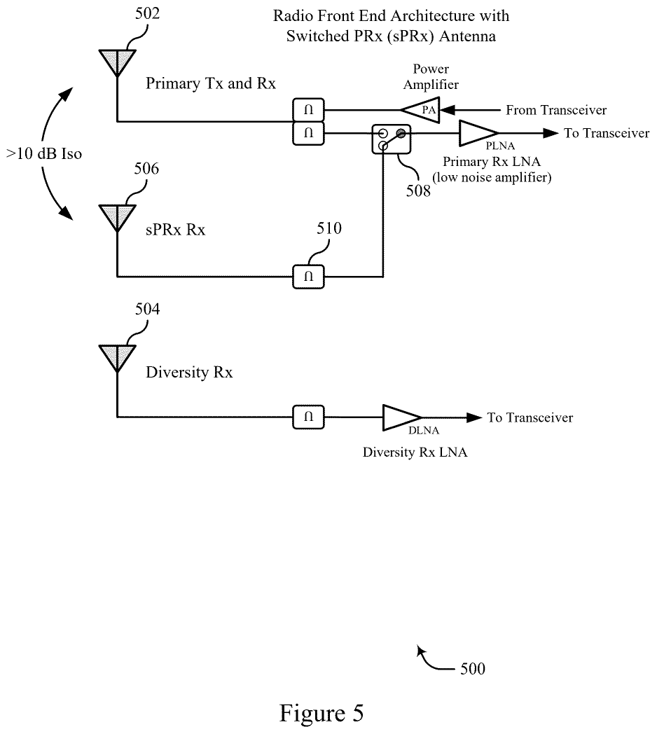

FIG. 5 illustrates an example HW configuration 500 that includes an sPRx with a duplicative Rx filter, in accordance with aspects of the present disclosure. In this example HW configuration 500, a radio front end architecture, such as may be implemented in a UE, includes a duplexed Tx and Rx antenna 502 that has a primary Tx antenna and a primary Rx antenna. The example HW configuration 500 may also include a diversity Rx antenna 504. In one or more implementations, the example HW configuration 500 also includes an additional physical Rx antenna, as the switchable primary Rx-only antenna (sPRx) 506 that may be switched to separate the primary Rx antenna from the primary Tx antenna of the duplexed transmit and receive antenna 502. The example HW configuration 500 also includes a switch 508 that may be activated by the UE to effectuate switching in the sPRx 506, and includes a duplicative (e.g., extra) filter 510.

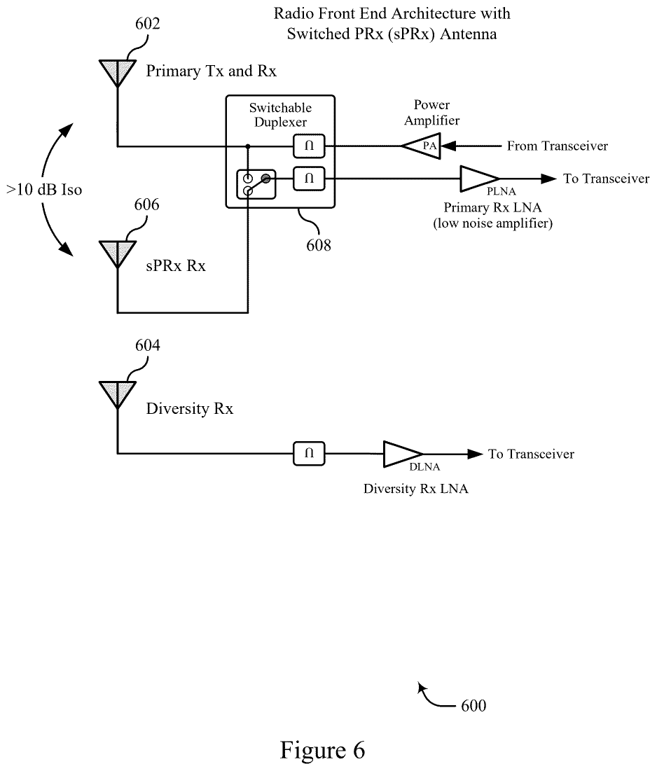

FIG. 6 illustrates another example HW configuration 600 that includes an sPRx that may be switched with a switchable duplexer, in accordance with aspects of the present disclosure. In this example HW configuration 600, a radio front end architecture, such as may be implemented in a UE, includes a duplexed Tx and Rx antenna 602 that has a primary Tx antenna and a primary Rx antenna. The example HW configuration 600 may also include a diversity Rx antenna 604. In one or more implementations, the example HW configuration 600 also includes an additional physical Rx antenna, as the switchable primary Rx-only antenna (sPRx) 606 that may be switched to separate the primary Rx antenna from the primary Tx antenna of the duplexed transmit and receive antenna 602. The example HW configuration 600 also includes a switchable duplexer 608 that may be activated by the UE to effectuate switching in the sPRx 606. Notably, this example HW configuration 600 does not require a duplicative (e.g., extra) filter, such as the filter 510 shown in FIG. 5.

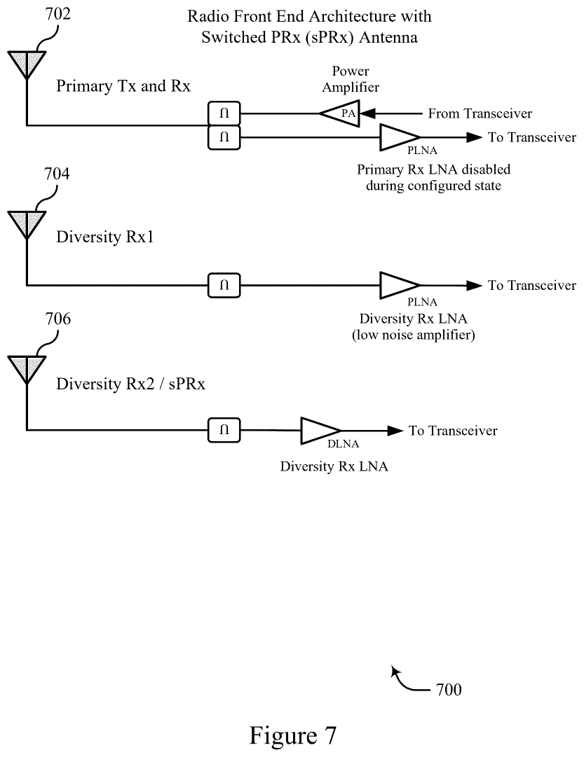

FIG. 7 illustrates another example HW configuration 700 that includes an sPRx implemented as a second diversity Rx antenna, in accordance with aspects of the present disclosure. In this example HW configuration 700, a radio front end architecture in a UE may be implemented with more than two receivers, similar to three Rx designs. The primary receiver may be shut down, saving current drain. In this example HW configuration 700, the radio front end architecture includes a duplexed Tx and Rx antenna 702 that has a primary Tx antenna and a primary Rx antenna. The example HW configuration 700 may also include a first diversity Rx1 antenna 704. In one or more implementations, the example HW configuration 700 also includes an additional diversity Rx2/sPRx antenna 706 that may be utilized during Rx operations.

In one or more implementations, a UE may include a primary receiver associated with the duplexed transmit and receive antenna 702, as well as the a first diversity Rx1 antenna 704 and the additional diversity Rx2/sPRx antenna 706. The UE may then disable the primary receiver, such as based on channel bandwidth and an uplink data rate during FDD operation, and enable the secondary receiver as a primary signal receiver. Some radio architectures already have more than two receivers and associated antennas. In this type of configuration, a UE can report this capability and instead of using a switched antenna, a third or fourth receiver may be activated if not in use as the primary receiver, and the receiver associated with the Tx antenna being corrupted by noise would be disabled. Accordingly, only the receivers that have low Tx self desense performance are active, thus reducing current drain by decoding and demodulating a known poor performing receiver.

In aspects of the described example HW configurations, the sPRx antenna would be isolated from the duplexed Tx and Rx antenna through physical distance, and may be optimized for antenna tuning having some degree of isolation at the Rx frequency band to the Tx antenna. In practice, a 10 dB to 30 dB of isolation may be achieved, depending on the physical location of the antennas in a device and optimized antenna tuning. As a result of this additional isolation, the noise from the Tx chain in the Rx frequency band at the primary Rx is reduced by the amount of antenna isolation. A UE can then achieve better performance in terms of coverage and throughput during high UL signal activity because the SNR will be more balanced between the antennas, have less variation, and allow for better DL MIMO performance. As indicated, a benefit of separating the primary Tx and Rx is that antenna tuning may be optimized for each sub-band and potentially simplified. In the low frequency bands, antenna bandwidth for duplex operation is large and difficult to achieve. With a switched separate scheme, antenna tuning can be better optimized to the subband, providing further benefits in this split mode of operation outside of managing Tx self desense.

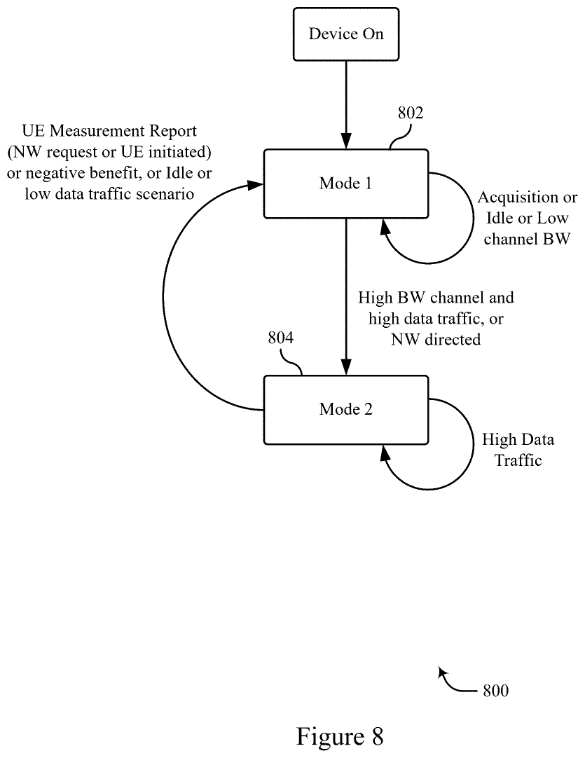

FIG. 8 illustrates example 800 of modes of operation utilizing an sPRx, in accordance with aspects of the present disclosure. In this example 800, a UE may operate in a first mode 802 with the duplexed Tx and Rx antenna enabled. The UE may also determine to switch from the first mode 802 to a second mode 804 and operate with the sPRx antenna switched in so that the primary Rx antenna is separated from the primary Tx antenna of the duplexed Tx and Rx antenna. Alternatively, or in addition, the UE may receive a request, such as from an NE (network) to switch from the first mode 802 to the second mode 804. Alternatively, or in addition, the UE may receive, such as from an NE, an instruction to switch from the second mode 804 back to the first mode 802, and the UE can then measure and report channel metrics for a primary Rx associated with the duplexed Tx and Rx antenna.

In one or more implementations, during acquisition and idle states, the UE may operate as normal (Mode 1) utilizing the duplexed physical antenna. The UE may advertise the HW capability through an information element (IE) as an optional feature (e.g., through a new IE). Either through NW control or by autonomous UE control, the UE may then switch the primary Rx to the separated physical antenna (Mode 2) for higher BW channels and data traffic. Alternatively, or in addition, the NW or the UE may determine to force the primary receiver back to the Tx antenna in duplex mode, so as to characterize the channel link for the purpose of estimating the UL Tx channel and measure RSRP for the purpose of Tx power adjustments and/or measuring neighbor cells, even though the channel is only quasi-reciprocal (Mode 1). Then the primary Rx could revert back to split Tx and primary Rx physical antennas for user data. In one or more implementations, the UE may autonomously switch between the modes for situations where the device uses algorithms related to antenna control, such as for antenna switched diversity (AS-DIV) or when the benefit of Tx desense improvement with the switched sPRx antenna does not exceed the default state performance. This may occur if the switched antenna is impaired by external factors.

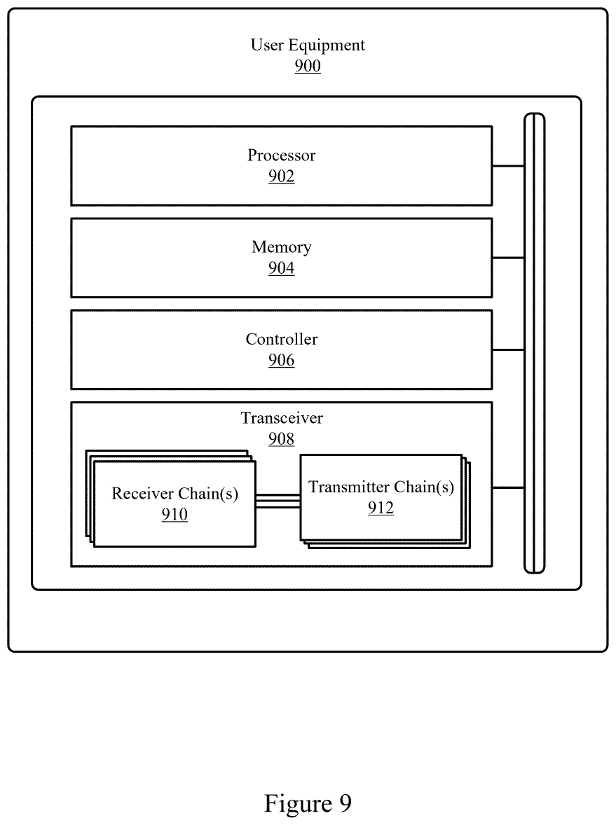

FIG. 9 illustrates an example of a UE 900 in accordance with aspects of the present disclosure. In some examples, the UE 900 may be an example of a UE as described with reference to FIGS. 1-8. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a central processing unit (CPU), an ASIC, a field-programmable gate array (FPGA), or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to or operable to cause the UE 900 to perform one or more of the functions described herein (e.g., executing, by the processor 902, instructions stored in the memory 904). For example, the processor 902 may support wireless communication at the UE 900 in accordance with examples as disclosed herein. The UE 900 may be configured to or operable to support a means for receiving wireless communication via a duplexed transmit and receive antenna comprising a primary transmit antenna and a primary receive antenna; and switching to a switchable physical receive-only antenna that separates the primary receive antenna from the primary transmit antenna of the duplexed transmit and receive antenna.

Additionally, or alternatively, the UE 900 may be configured to or operable to support any one or combination of the switchable physical receive-only antenna is isolated from the primary transmit antenna based at least in part on a physical distance between the switchable physical receive-only antenna and the primary transmit antenna. The duplexed transmit and receive antenna is configured for FDD operation for simultaneous two-way transmit and receive; and the method further comprising detecting channel bandwidth during the FDD operation, and switching to the switchable physical receive-only antenna based on one or more of the channel bandwidth, assigned resources, a data rate. The method further comprising transmitting a capability message that indicates the UE is configured with at least the switchable physical receive-only antenna. The UE comprises the duplexed transmit and receive antenna, the switchable physical receive-only antenna, and at least one diversity receive antenna; and the method further comprising disabling the receive antenna of the duplexed transmit and receive antenna, and enabling the switchable physical receive-only antenna and the at least one diversity receive antenna for FDD. The UE comprises a primary receiver associated with the duplexed transmit and receive antenna, and at least one secondary receiver and associated diversity receive antenna; and the method further comprising disabling the primary receiver based at least in part on channel bandwidth and an UL data rate during FDD operation, and enabling the at least one secondary receiver as a primary signal receiver. The method further comprising operating in a first mode with the duplexed transmit and receive antenna enabled; or operating in a second mode with the switchable physical receive-only antenna and the primary receive antenna separated from the primary transmit antenna of the duplexed transmit and receive antenna; and at least one of determining to switch from the first mode to the second mode, or receiving, from a NE, a request to switch from the first mode to the second mode. The method further comprising receiving, from the NE, an instruction to switch from the second mode to the first mode, and measuring channel metrics for a primary receiver associated with the duplexed transmit and receive antenna.

Additionally, or alternatively, the UE 900 may support a duplexed transmit and receive antenna comprising a primary transmit antenna and a primary receive antenna; a switchable physical receive-only antenna; as well as at least one memory (e.g., the memory 904) and at least one processor (e.g., the processor 902) coupled with the at least one memory and configured to or operable to cause the UE to switch to the switchable physical receive-only antenna to separate the primary receive antenna from the primary transmit antenna of the duplexed transmit and receive antenna.

Additionally, the UE 900 may be configured to support any one or combination of the switchable physical receive-only antenna is isolated from the primary transmit antenna based at least in part on a physical distance between the switchable physical receive-only antenna and the primary transmit antenna. The at least one processor is operable to cause the UE to optimize antenna tuning based at least in part on isolation of the switchable physical receive-only antenna from the primary transmit antenna that is separated from the primary receive antenna. The duplexed transmit and receive antenna is configured for FDD operation for simultaneous two-way transmit and receive; and the at least one processor is operable to cause the UE to detect channel bandwidth during the FDD operation, and switch to the switchable physical receive-only antenna based on one or more of the channel bandwidth, assigned resources, or data rate. The at least one processor is operable to cause the UE to transmit a capability message that indicates the UE is configured with at least the switchable physical receive-only antenna. The capability message further indicates an UL allocation that is supported by an antenna configuration of the UE. The UE comprises the duplexed transmit and receive antenna, the switchable physical receive-only antenna, and at least one diversity receive antenna; and the at least one processor is operable to cause the UE to disable the receive antenna of the duplexed transmit and receive antenna, and enable the switchable physical receive-only antenna and the at least one diversity receive antenna for FDD. The UE comprises a primary receiver associated with the duplexed transmit and receive antenna, and at least one secondary receiver and associated diversity receive antenna; and the at least one processor is operable to cause the UE to disable the primary receiver based at least in part on channel bandwidth and an uplink data rate during FDD operation; and enable the at least one secondary receiver as a primary signal receiver. The at least one processor is operable to cause the UE to operate in a first mode with the duplexed transmit and receive antenna enabled; or operate in a second mode with the switchable physical receive-only antenna and the primary receive antenna separated from the primary transmit antenna of the duplexed transmit and receive antenna; and at least one of determine, by the UE, to switch from the first mode to the second mode; or receive, from a NE, a request to switch from the first mode to the second mode. The at least one processor is operable to cause the UE to receive, from the NE, an instruction to switch from the second mode to the first mode; and measure and report channel metrics for a primary receiver associated with the duplexed transmit and receive antenna.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

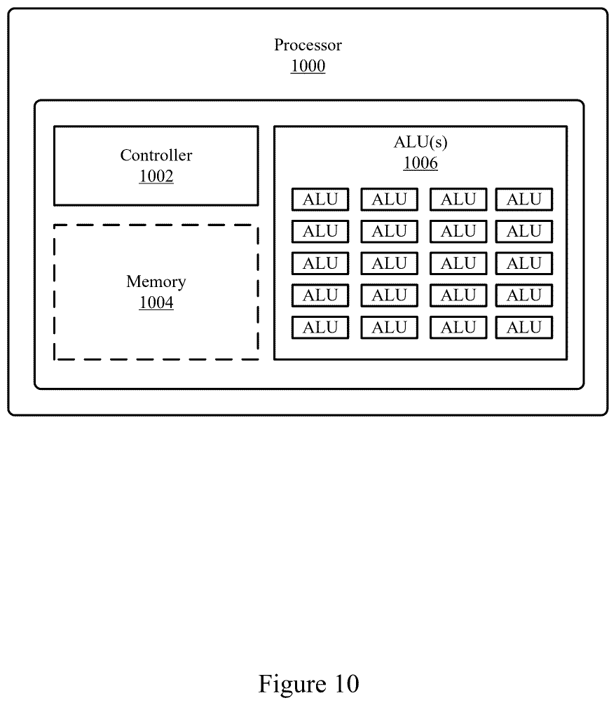

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to support at least one controller (e.g., the controller 1002) coupled with at least one memory (e.g., the memory 1004) and configured to or operable to cause the processor to switch to a switchable physical receive-only antenna to separate a primary receive antenna from a primary transmit antenna of a duplexed transmit and receive antenna, where a UE includes the duplexed transmit and receive antenna comprising the primary transmit antenna and the primary receive antenna; and the UE includes the switchable physical receive-only antenna.

Additionally, the processor 1000 may be configured to or operable to support any one or combination of the switchable physical receive-only antenna is isolated from the primary transmit antenna based at least in part on a physical distance between the switchable physical receive-only antenna and the primary transmit antenna. The processor is operable to optimize antenna tuning based at least in part on isolation of the switchable physical receive-only antenna from the primary transmit antenna that is separated from the primary receive antenna. The duplexed transmit and receive antenna is configured for FDD operation for simultaneous two-way transmit and receive; and the processor is operable to detect channel bandwidth during the FDD operation, and switch to the switchable physical receive-only antenna based on one or more of the channel bandwidth, assigned resources, or data rate. The processor is operable to transmit a capability message that indicates the UE is configured with at least the switchable physical receive-only antenna. The capability message further indicates an UL allocation that is supported by an antenna configuration of the UE. The UE comprises the duplexed transmit and receive antenna, the switchable physical receive-only antenna, and at least one diversity receive antenna; and the processor is operable to disable the receive antenna of the duplexed transmit and receive antenna, and enable the switchable physical receive-only antenna and the at least one diversity receive antenna for FDD. The UE comprises a primary receiver associated with the duplexed transmit and receive antenna, and at least one secondary receiver and associated diversity receive antenna; and the processor is operable to disable the primary receiver based at least in part on channel bandwidth and an uplink data rate during FDD operation; and enable the at least one secondary receiver as a primary signal receiver. The processor is operable to operate in a first mode with the duplexed transmit and receive antenna enabled; or operate in a second mode with the switchable physical receive-only antenna and the primary receive antenna separated from the primary transmit antenna of the duplexed transmit and receive antenna; and at least one of determine, by the UE, to switch from the first mode to the second mode; or receive, from a NE, a request to switch from the first mode to the second mode. The processor is operable to receive, from the NE, an instruction to switch from the second mode to the first mode; and measure and report channel metrics for a primary receiver associated with the duplexed transmit and receive antenna.

The processor 1000 may support wireless communication in accordance with examples as disclosed herein. The processor 1000 may be configured to support at least one controller (e.g., the controller 1002) coupled with at least one memory (e.g., the memory 1004) and configured to or operable to cause the processor to receive, from a UE, a capability message that indicates the UE is configured with a switchable physical receive-only antenna, as well as a duplexed transmit and receive antenna comprising a primary transmit antenna and a primary receive antenna; and transmit, to the UE, a request to switch from a first mode to a second mode, where the UE is configured to at least one of operate in the first mode with the duplexed transmit and receive antenna enabled, or operate in the second mode with the switchable physical receive-only antenna and the primary receive antenna separated from the primary transmit antenna of the duplexed transmit and receive antenna.

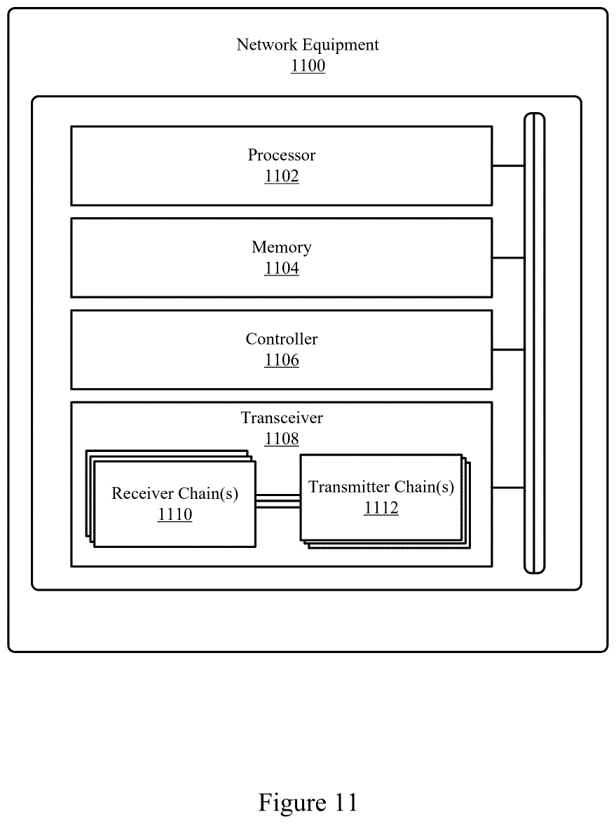

FIG. 11 illustrates an example of an NE 1100 in accordance with aspects of the present disclosure. In some examples, the NE 1100 may be an example of an NE as described with reference to FIGS. 1-8. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to or operable to support a means for receiving, from a UE, a capability message that indicates the UE is configured with a switchable physical receive-only antenna, as well as a duplexed transmit and receive antenna comprising a primary transmit antenna and a primary receive antenna; and transmitting, to the UE, a request to switch from a first mode to a second mode, where the UE is configured to at least one of operate in the first mode with the duplexed transmit and receive antenna enabled, or operate in the second mode with the switchable physical receive-only antenna and the primary receive antenna separated from the primary transmit antenna of the duplexed transmit and receive antenna.

Additionally, or alternatively, the NE 1100 may support at least one memory (e.g., the memory 1104) and at least one processor (e.g., the processor 1102) coupled with the at least one memory and configured to or operable to cause the NE to receive, from a UE, a capability message that indicates the UE is configured with a switchable physical receive-only antenna, as well as a duplexed transmit and receive antenna comprising a primary transmit antenna and a primary receive antenna; and transmit, to the UE, a request to switch from a first mode to a second mode, where the UE is configured to at least one of operate in the first mode with the duplexed transmit and receive antenna enabled, or operate in the second mode with the switchable physical receive-only antenna and the primary receive antenna separated from the primary transmit antenna of the duplexed transmit and receive antenna.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., an LNA) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

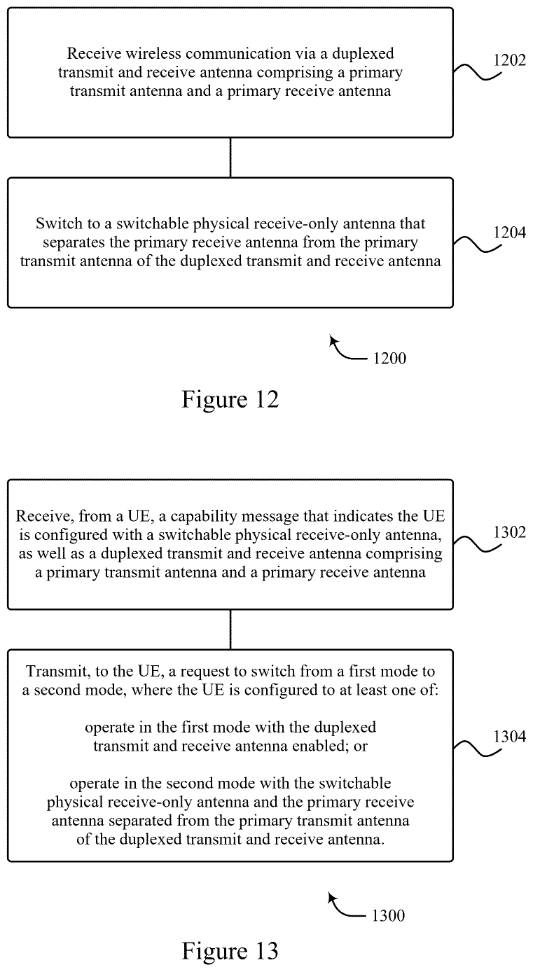

FIG. 12 illustrates a flowchart of a method 1200 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1202, the method may include receiving wireless communication via a duplexed transmit and receive antenna comprising a primary transmit antenna and a primary receive antenna. The operations of 1202 may be performed in accordance with examples as described herein. In some implementations, aspects of the operations of 1202 may be performed by the UE 900 as described with reference to FIG. 9.

At 1204, the method may include switching to a switchable physical receive-only antenna that separates the primary receive antenna from the primary transmit antenna of the duplexed transmit and receive antenna. The operations of 1204 may be performed in accordance with examples as described herein. In some implementations, aspects of the operations of 1204 may be performed by the UE 900 as described with reference to FIG. 9.

FIG. 13 illustrates a flowchart of a method 1300 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1302, the method may include receiving, from a UE, a capability message that indicates the UE is configured with a switchable physical receive-only antenna, as well as a duplexed transmit and receive antenna comprising a primary transmit antenna and a primary receive antenna. The operations of 1302 may be performed in accordance with examples as described herein. In some implementations, aspects of the operations of 1302 may be performed by the NE 1100 as described with reference to FIG. 11.

At 1304, the method may include transmitting, to the UE, a request to switch from a first mode to a second mode, where the UE is configured to at least one of operate in the first mode with the duplexed transmit and receive antenna enabled, or operate in the second mode with the switchable physical receive-only antenna and the primary receive antenna separated from the primary transmit antenna of the duplexed transmit and receive antenna. The operations of 1304 may be performed in accordance with examples as described herein. In some implementations, aspects of the operations of 1304 may be performed by the NE 1100 as described with reference to FIG. 11.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
a duplexed transmit and receive antenna comprising a primary transmit antenna and a primary receive antenna;
a switchable physical receive-only antenna;
at least one memory; and
at least one processor coupled with the at least one memory and operable to cause the UE to switch to the switchable physical receive-only antenna to separate the primary receive antenna from the primary transmit antenna of the duplexed transmit and receive antenna.

2. The UE of claim 1, wherein the switchable physical receive-only antenna is isolated from the primary transmit antenna based at least in part on a physical distance between the switchable physical receive-only antenna and the primary transmit antenna.

3. The UE of claim 1, wherein the at least one processor is operable to cause the UE to optimize antenna tuning based at least in part on isolation of the switchable physical receive-only antenna from the primary transmit antenna that is separated from the primary receive antenna.

4. The UE of claim 1, wherein:
the duplexed transmit and receive antenna is configured for frequency division duplexing (FDD) operation for simultaneous two-way transmit and receive; and
the at least one processor is operable to cause the UE to detect channel bandwidth during the FDD operation, and switch to the switchable physical receive-only antenna based on one or more of the channel bandwidth, assigned resources, or data rate.

5. The UE of claim 1, wherein the at least one processor is operable to cause the UE to transmit a capability message that indicates the UE is configured with at least the switchable physical receive-only antenna.

6. The UE of claim 5, wherein the capability message further indicates an uplink (UL) allocation that is supported by an antenna configuration of the UE.

7. The UE of claim 1, wherein:
the UE comprises the duplexed transmit and receive antenna, the switchable physical receive-only antenna, and at least one diversity receive antenna; and
the at least one processor is operable to cause the UE to:
disable the receive antenna of the duplexed transmit and receive antenna; and
enable the switchable physical receive-only antenna and the at least one diversity receive antenna for frequency division duplexing (FDD).

8. The UE of claim 1, wherein:
the UE comprises a primary receiver associated with the duplexed transmit and receive antenna, and at least one secondary receiver and associated diversity receive antenna; and
the at least one processor is operable to cause the UE to:
disable the primary receiver based at least in part on channel bandwidth and an uplink data rate during frequency division duplexing (FDD) operation; and
enable the at least one secondary receiver as a primary signal receiver.

9. The UE of claim 1, wherein the at least one processor is operable to cause the UE to:
operate in a first mode with the duplexed transmit and receive antenna enabled; or
operate in a second mode with the switchable physical receive-only antenna and the primary receive antenna separated from the primary transmit antenna of the duplexed transmit and receive antenna; and at least one of:
determine, by the UE, to switch from the first mode to the second mode; or
receive, from a network equipment (NE), a request to switch from the first mode to the second mode.

10. The UE of claim 9, wherein the at least one processor is operable to cause the UE to:
receive, from the NE, an instruction to switch from the second mode to the first mode; and
measure and report channel metrics for a primary receiver associated with the duplexed transmit and receive antenna.

11. A method performed by a user equipment (UE), the method comprising:
receiving wireless communication via a duplexed transmit and receive antenna comprising a primary transmit antenna and a primary receive antenna; and
switching to a switchable physical receive-only antenna that separates the primary receive antenna from the primary transmit antenna of the duplexed transmit and receive antenna.

12. The method of claim 11, wherein the switchable physical receive-only antenna is isolated from the primary transmit antenna based at least in part on a physical distance between the switchable physical receive-only antenna and the primary transmit antenna.

13. The method of claim 11, wherein the duplexed transmit and receive antenna is configured for frequency division duplexing (FDD) operation for simultaneous two-way transmit and receive; and the method further comprising:
detecting channel bandwidth during the FDD operation; and
switching to the switchable physical receive-only antenna based on one or more of the channel bandwidth, assigned resources, a data rate.

14. The method of claim 11, further comprising:
transmitting a capability message that indicates the UE is configured with at least the switchable physical receive-only antenna.

15. The method of claim 11, wherein the UE comprises the duplexed transmit and receive antenna, the switchable physical receive-only antenna, and at least one diversity receive antenna; and the method further comprising:
disabling the receive antenna of the duplexed transmit and receive antenna; and
enabling the switchable physical receive-only antenna and the at least one diversity receive antenna for frequency division duplexing (FDD).

16. The method of claim 11, wherein the UE comprises a primary receiver associated with the duplexed transmit and receive antenna, and at least one secondary receiver and associated diversity receive antenna; and the method further comprising:
disabling the primary receiver based at least in part on channel bandwidth and an uplink data rate during frequency division duplexing (FDD) operation; and
enabling the at least one secondary receiver as a primary signal receiver.

17. The method of claim 11, further comprising:
operating in a first mode with the duplexed transmit and receive antenna enabled; or
operating in a second mode with the switchable physical receive-only antenna and the primary receive antenna separated from the primary transmit antenna of the duplexed transmit and receive antenna; and at least one of:
determining to switch from the first mode to the second mode; or
receiving, from a network equipment (NE), a request to switch from the first mode to the second mode.

18. The method of claim 17, further comprising:
receiving, from the NE, an instruction to switch from the second mode to the first mode; and
measuring channel metrics for a primary receiver associated with the duplexed transmit and receive antenna.

19. A network equipment (NE) for wireless communication, comprising:
at least one memory; and
at least one processor coupled with the at least one memory and operable to cause the NE to:
receive, from a user equipment (UE), a capability message that indicates the UE is configured with a switchable physical receive-only antenna, as well as a duplexed transmit and receive antenna comprising a primary transmit antenna and a primary receive antenna; and
transmit, to the UE, a request to switch from a first mode to a second mode, wherein the UE is configured to at least one of:
operate in the first mode with the duplexed transmit and receive antenna enabled; or
operate in the second mode with the switchable physical receive-only antenna and the primary receive antenna separated from the primary transmit antenna of the duplexed transmit and receive antenna.

20. A method performed by a network equipment (NE), the method comprising:
receiving, from a user equipment (UE), a capability message that indicates the UE is configured with a switchable physical receive-only antenna, as well as a duplexed transmit and receive antenna comprising a primary transmit antenna and a primary receive antenna; and
transmitting, to the UE, a request to switch from a first mode to a second mode, wherein the UE is configured to at least one of:
operate in the first mode with the duplexed transmit and receive antenna enabled; or
operate in the second mode with the switchable physical receive-only antenna and the primary receive antenna separated from the primary transmit antenna of the duplexed transmit and receive antenna.
